(19) United States
(12) Patent Application Publication
(10) Pub. No.: US 2021/0339533 A1
(43) Pub. Date: Nov. 4, 2021

(54) DETERMINING SPIT LOCATIONS

(71) Applicant: Hewlett-Packard Development Company, L.P., Spring, TX (US)

(72) Inventor: Li Qian, Sant Cugat del Valles (ES)

(21) Appl. No.: 17/271,781

(22) PCT Filed: Nov. 20, 2018
(86) PCT No.: PCT/US2018/062080

§ 371 Date: Feb. 26, 2021

(51) Int. Cl. B41J 2/165; B41J 2/17

(52) U.S. Cl. CPC B41J 2/16505; B41J 2/1721

(57) ABSTRACT

An example of a printing apparatus is disclosed. The printing apparatus comprises a carriage comprising a printhead to spit a printing fluid, the carriage to move over a service zone and a print zone. The printing apparatus also comprises a controller to determine a spit location within the service zone associate with the printing fluid; and spit, during the service operation, an amount of the printing fluid at the spit location of the service zone associated to the printing fluid.

### BACKGROUND

Inkjet printers are systems that generate a printed image by propelling printing liquid through nozzles onto printing media locations associated with virtual pixels. The printing liquid drops may comprise pigments or dyes disposed in a liquid vehicle. In some examples, the printing fluid may be stored in a printing fluid repository. The accuracy of the selection of a dye concentration, and/or a pigment concentration may influence the control of the printing liquid propelling onto the substrate. Additionally, or alternatively, the accuracy in which the printing fluid drops are placed in the printing media locations may lead to a better print job quality or image quality (IQ).

### BRIEF DESCRIPTION OF THE DRAWINGS

The present application may be more fully appreciated in connection with the following detailed description taken in conjunction with the accompanying drawings, in which like reference characters refer to like parts throughout and in which:

FIG. 1 is a block diagram illustrating an example of a printing apparatus to determine a spit location.

FIG. 2A is a block diagram illustrating an example of a front view of a printing apparatus to determine a spit location.

FIG. 2B is a block diagram illustrating another example of a front view of a printing apparatus to determine a spit location.

FIG. 3A is a block diagram illustrating an example of a top view of a service zone with a plurality of spit locations.

FIG. 3B is a block diagram illustrating an example of a front view of a service zone with a plurality of spit locations.

FIG. 3C is a block diagram illustrating another example of a front view of a service zone with a plurality of spit locations.

FIG. 4 is a flowchart of an example method for determining a spit location.

FIG. 5 is a block diagram illustrating an example of a processor-based system to determine a spit location.

### DETAILED DESCRIPTION

The following description is directed to various examples of the disclosure. In the foregoing description, numerous details are set forth to provide an understanding of the examples disclosed herein. However, it may be understood by those skilled in the art that the examples may be practiced without these details. While a limited number of examples have been disclosed, those skilled in the art may appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

In the present disclosure reference is made to a printing system, printing apparatus, printing device, and/or printer. The terms “printing system”, “printing apparatus”, “printing device”, and/or “printer” should be read in their broad definition, therefore being any image recording system that uses at least one printhead. In an example, the printing apparatus may be a two-dimensional (2D) desk printer. In another example, the printing system may be a 2D large format printer. In another example, the printing system may be a printing press, for example, an offset printing press. In yet another example, the printing system may be a three-dimensional (3D) printer and/or an additive manufacturing system.

Some examples of printers comprise a plurality of nozzles distributed across a single or a plurality of printheads, wherein each nozzle is assigned to a single printing fluid. In the present disclosure, the term “nozzle” should be interpreted as any cylindrical or round spout at the end of a pipe hose, or tube used to control a jet of printing fluid.

During a printing operation, some nozzles may not propel printing fluid for an amount of time and, therefore the printing fluid located in the tip of the nozzle may experience direct contact with ambient air. If a portion of a printing fluid experiences direct contact with ambient air, the concentration of the portion of a printing fluid may vary. The concentration of a printing fluid may vary since the direct contact with ambient air may evaporate, at least in part, the liquid carrier of the printing fluid, therefore increasing the concentration of the dye of the printing fluid and/or the concentration of the pigment of the printing fluid with respect with the remaining liquid carrier. In these conditions, the drops of the printing fluid may be hard to control, and additional uncontrolled satellites may occur, leading to a reduction of the IQ of the print job. This issue, may be known as the so-called “decap”.

Precisely, the “decap time” is the time in which a nozzle is uncapped, i.e. the time in which the concentration of the printing fluid does not vary due to the contact with ambient air. In an example, a nozzle is unused for an amount of time greater than the decap time, then the nozzle is most likely going to lead to decap issues, therefore experiencing a reduction of the IQ of the print job. In another example, a nozzle is unused for an amount of time shorter than the decap time, then the nozzle is most likely not going to lead to decap issues, therefore not experiencing any reduction of the IQ of the print job. The decap time may vary depending on many parameters that may affect the change of the printing fluid properties due to decap, for example, the printing fluid composition, temperature, humidity, size of the nozzle bore, and the like. The distance travelled by the printhead the nozzle and printing fluid associated with the decap time is also known as “decap distance”. The decap distance is based on the decap time of a printing fluid and the speed that the nozzle travels, i.e. the speed of the printhead comprising the nozzle.

The plurality of nozzles may eject a printing fluid. In an example, the printing fluid may comprise a colorant and/or dye with a liquid carrier (e.g., cartridges and/or liquid toners). Some printing fluids may be dye based printing fluids, where dyes may be understood as a coloring solution. Other printing fluids may be pigment based printing fluids, where pigments may be understood as coloring particles in suspension. In another example, the printing fluid may comprise ink particles and an imaging oil liquid carrier (e.g., liquid toner ink commercially known as HP ElectroInk from HP Inc.). In another example, the printing fluid is an additive manufacturing fusing agent which may be an ink-type formulation comprising carbon black, such as, for example, the fusing agent formulation commercially known as V1Q60A “HP fusing agent” available from HP Inc. In an additional example such a fusing agent may additionally comprise an infra-red light absorber. In another additional example, such a fusing agent may additionally comprise a visible light absorber. In yet another additional example such fusing agent may additionally comprise a UV light absorber. Examples of inks comprising visible light enhancers are dye-based colored ink and pigment-based colored ink (e.g., inks commercially known as CE039A and CE042A available from HP Inc.). In yet another example, the printing fluid may be a suitable additive manufacturing detailing agent (e.g., formulation commercially known as V1Q61A “HP detailing agent” available from HP Inc.). A plurality of examples of the printing fluid that may be propelled by a nozzle has been disclosed, however any other chemical printing fluid comprising an agent in a liquid solvent or in a liquid carrier that may evaporate in contact with ambient air may be used without departing from the scope of the present disclosure.

Some printing apparatuses comprise scanning printheads. Scanning printheads are printheads that are to move above and across the width of the media by propelling printing fluid thereon through printing passes or swaths. The term “swath” may be interpreted as the operation in which the scanning printhead moves at least from an edge of the width of the printing medium to the opposite edge of the printing medium. During a swath, a nozzle from the printhead may selectively propel an amount of the printing fluid therethrough.

Some examples of printing systems may comprise a service zone at the end of the width of the media to propel or spit printing fluid thereon to reduce the likelihood of decap occurrence. In the present disclosure, a “spit” may be interpreted as the ejection operation of a predetermined quantity of printing fluid. In some examples, a spit of printing fluid may be for purposes of reducing the likelihood of decap occurrence, and not necessarily for purposes of performing the print job. Precisely, a spit may be performed at the service zones to refresh the nozzles. These spits are the so-called servicing spits.

As mentioned above, in some examples, servicing spits are performed in service zones. Precisely, servicing spits of a swath are all performed in the same location of the service zone. The spat printing fluid accumulates in the location it was ejected and this may cause issues that lead to a potential replacement of the service zone.

The decap time associated with a printing fluid may vary depending on the composition of the printing fluid. In an example, the decap time associated with a printing fluid comprising a Magenta colorant may be longer than the decap time associated with a printing fluid comprising a Yellow colorant. Servicing spits may be performed throughout the length of a service zone.

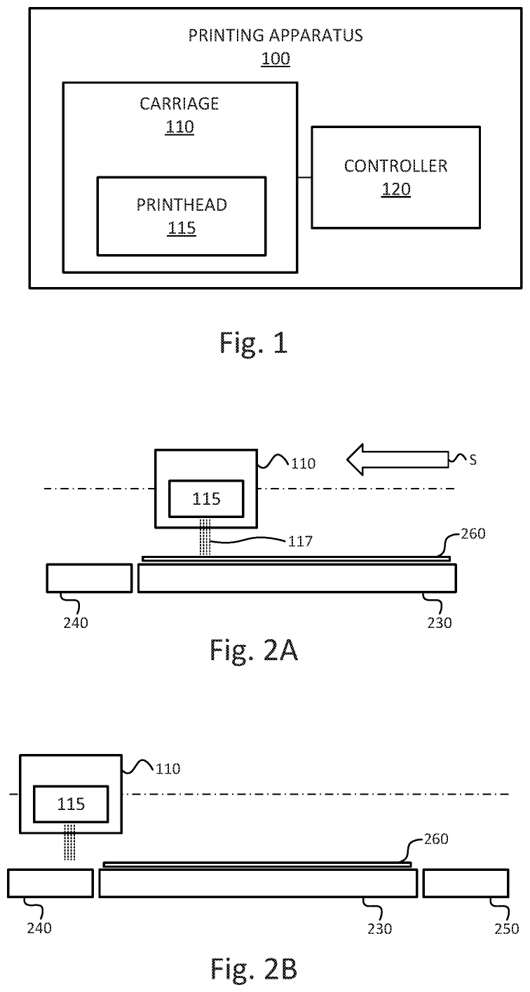

Referring now to the drawings, FIG. 1 is a block diagram illustrating an example of a printing apparatus 100 to determine a spit location. The printing apparatus 100 comprises a carriage 110 to move over a service zone and a print zone. The carriage 110 comprises at least one printhead 115 to eject a printing fluid. In some examples, the printhead 115 is to eject a single printing fluid, e.g. magenta printing fluid. In other examples, the printhead 115 is to eject a plurality of printing fluids, e.g. magenta and yellow printing fluids. The printing apparatus 100 also comprises a controller 120.

The controller 120 may be any combination of hardware and programming to implement the functionalities described herein. In some examples herein, such combinations of hardware and programming may be implemented in a number of different ways. For example, the programming of modules may be processor-executable instructions stored on at least one non-transitory machine-readable storage medium and the hardware for modules may include at least one processor to execute those instructions. In some examples described herein, multiple modules may be collectively implemented by a combination of hardware and programming, as described above. In other examples, the functionalities of the controller 120 may be, at least partially, implemented in the form of electronic circuitry.

The print zone is the area where an amount of a printing fluid can be spat to perform the print job. As mentioned above, the service zone is an area remote to the print zone in which an amount of the printing fluid is spat to reduce the likelihood of decap occurrence. In an example, the service zone may be near or adjacent to the printing zone. A service zone comprises a plurality of locations where printing fluid may be spat onto. Some locations from the service zone are closer to the printing zone than others. Determining in which location to spit an amount of the printing fluid may lead to an enhanced printing performance.

The controller 120 is to determine a spit location within the service zone associated to the printing fluid. For example, the controller 120 may determine the spit location of a first printing fluid in a first location of the service zone. The first location of the service zone may be the location from the service zone that is the closest to the printing zone. In another example, the controller 120 may determine the spit location of a first printing fluid in a second location of the service zone. The second location of the service zone may be the location from the service zone that is the furthest to the printing zone. In yet another example, the controller 120 may determine the spit location of a first printing fluid in a third location of the service zone. The third location of the service zone may be a location between the first location and the second location. In further examples, the printhead 115 may comprise a plurality of printing fluids, the controller 120 may be to determine different spit locations from the service zone for each of the plurality of printing fluids.

During a service operation, i.e. spitting at the service zone, the controller 120 is further to instruct the printhead 115 to spit an amount of the printing fluid on the previously determined spit location of the service zone associated to the printing fluid. In an example, the amount of printing fluid to be spit may be the amount that may uncap a nozzle comprising the printing fluid, i.e. refresh the nozzles associated with the printing fluid. In other examples in which the printhead 115 comprises a plurality of printing fluids, the amount to uncap the nozzles may be a different amount depending on each printing fluid from the plurality of printing fluids. Additionally, or alternatively, the location from the service zone to spit the amount of each printing fluid may be a different location.

FIG. 2A is a block diagram illustrating an example of a front view of a printing apparatus to determine a spit location. The printing apparatus comprises the carriage 110, the printhead 115 and the controller 120 (not shown for simplicity). The printing apparatus also comprises a print zone 230 and a service zone 240 located adjacent to the print zone 230 along a swath direction (S). The carriage 110 may move substantially parallel and over the surface of the print zone 230 and service zone 240, see e.g., the swath direction (S).

The printhead 115 is to spit an amount of printing fluid 117 (illustrated as substantially vertical dotted lines) on the printing medium 260. The printing medium 260 may rest on top of the print zone 230. The amount of printing fluid and the location of the spits on the printing medium 260 may correspond to the print job to be printed. The printhead 115 is also to move and spit an amount of the printing fluid at the service zone 240. The controller 120 may instruct the printhead 115 to spit an amount of the printing fluid in the corresponding location from the service zone 240 based on the print job to be printed. The controller 120 may select the amount of printing fluid to be spit at the service zone, and the location of the service zone to spit the amount of printing fluid, based, for example, on the determinations according to the example of FIG. 1.

A wide variety of printing mediums 260 may be used. In an example, a paper substrate may be used. Other examples may use different types of substrates, such as a fabric substrate (e.g., textile fabric), a polymeric substrate, and/or additive manufacturing build material. These are examples of printing medium 260; however, other substrates may be used without departing from the scope of the preset disclosure.

FIG. 2B is a block diagram illustrating another example of a front view of a printing apparatus to determine a spit location. The printing apparatus comprises the carriage 110, the printhead 115, the controller 120 (not shown for simplicity), the print zone 230, the service zone 240, and the printing medium 260. The printing apparatus also comprises an additional service zone 250 located adjacent to the print zone 230. The service zone 240 and the additional service zone 250 may be placed adjacent but in different sides from the print zone 230, e.g. opposite sides. The carriage 110 may move substantially parallel and over the surface of the print zone 230, the service zone 240, and the additional service zone 250; see e.g., direction defined by the illustrated substantially horizontal dotted lines.

In an example, the service zone 240 may comprise a material formed by trapping pockets of gas in a solid, i.e. foam material. In another example, the service zone 240 may comprise a wiper. In yet another example, the service zone 240 may comprise a cleaning roll including fibers, e.g. polymeric fibers. In additional examples, the service zone 240 may comprise a spittoon. The additional service zone 250 may comprise the same or different elements as of the service zone 240.

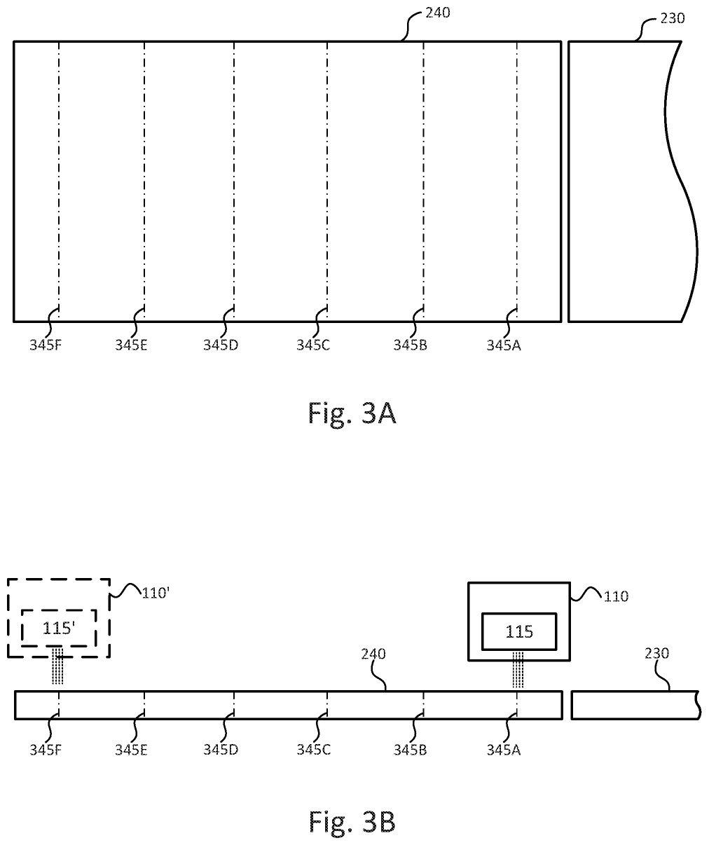

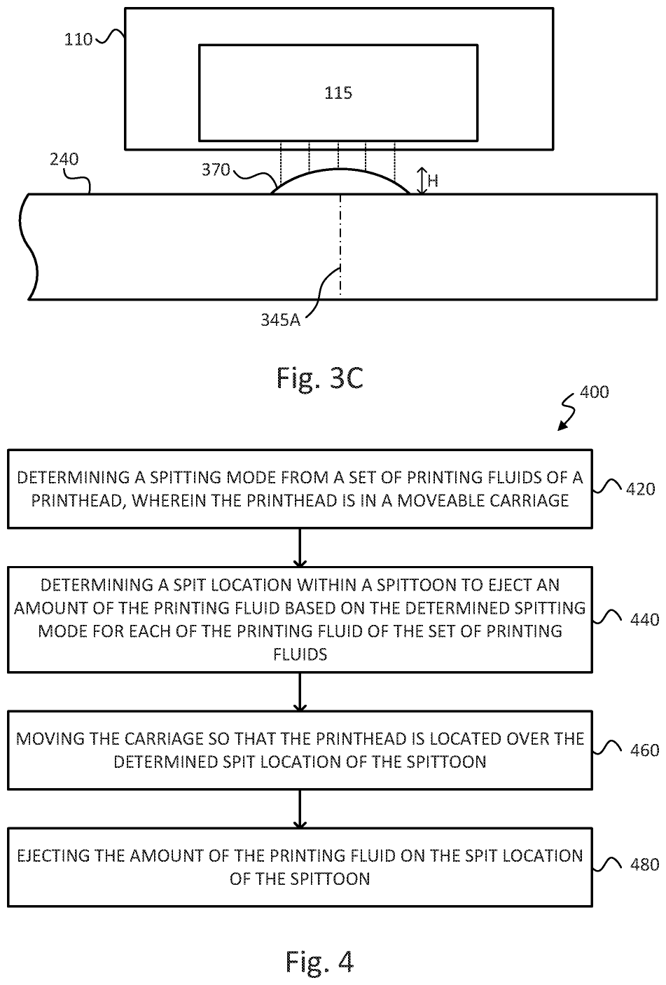

FIG. 3A and FIG. 3B are block diagrams illustrating an example of a top view and front view respectively of a service 240 zone with a plurality of spit locations 345A-345F. The service zone 240 is an area adjacent to the print zone 230. In the example, the service zone 240 may comprise a plurality of spit locations 345A-345F (illustrated as dotted lines).

The service zone 240 may comprise a first spit location 345A which may be the spit location closest to the print zone 230. The service zone 240 may also comprise a second spit location 345B, which is a spit location located next to the first spit location 345A. The service zone 240 may comprise a third spit location 345C, which is a spit location located next to the second spit location 345B. The service zone 240 may comprise a fourth spit location 345D, which is a spit location located next to the third spit location 345C. The service zone 240 may comprise a fifth spit location 345E, which is a spit location located next to the fourth spit location 345D. The service zone 240 may comprise a sixth spit location 345F, which is a spit location located next to the fifth spit location 345E. The sixth spit location 345F may be the furthest spit location within the service zone 240 from the print zone 230. The example comprises six spit locations 345A-345F for simplicity, however other examples may comprise more or less spit locations without departing from the scope of the present disclosure.

The printing apparatus further comprises the carriage 110 and the printhead 115. In some examples, the printhead 115 may comprise a plurality of printing fluids to be spit onto the print zone 230 to perform the print job. The controller 120 (not shown for simplicity) may control the printhead 115 to spit an amount of printing fluid in a specific spit location to refresh the nozzles therein. In an example, the controller 120 may assign each printing fluid from the printhead 115 to a spit location from the service zone 240, for example the controller 120 may assign each printing fluid to a different spit location. Following with the example, the controller 120 may instruct the printhead 115 to spit an amount of a first printing fluid on the first spitting zone 345A (carriage 110 and printhead 115 illustrated in solid lines). The controller 120 may also instruct the printhead 115 to spit an amount of a second printing fluid on the sixth spitting zone 345F (carriage 110′ and printhead 115′ illustrated in dashed lines). This is an example, and the controller 120 may control the printhead 150 to spit an amount of any printing fluid therein in any of the spit locations 345A-345F described above.

In an example in which the printhead 115 comprises a plurality of printing fluids, the controller 120 may determine a spit location within the service zone 240 associated to each of the printing fluids. In order to determine the spit location, the controller 120 (or a separate internal or external controller from the printing apparatus referred hereinafter as the controller 120) may obtain a parameter from the plurality of printing fluids through a sensing device or a memory, e.g. a look up table (LUT). In some examples, obtaining the parameter may involve a detection. In an example, the parameter may be a decap parameter, i.e. a parameter that indicates the likelihood of decap occurrence. As mentioned above, the decap time may vary based on the chemical composition of each of the printing fluids to be spited. Therefore, as an example, the parameter to be detected may be the decap time of each of the plurality of printing fluids. Likewise, the decap distance may also be used. The decap time and the decap distance may be comprised by the term decap parameter.

The controller 120 may determine the decap parameter based on different variables. The controller 120 may determine the decap parameter based on the print mode. The print mode may be understood as the selection of the values of the parameters and/or features that may have an effect in a printing operation. In an example, the print mode may comprise at least one parameter of the group defined by ink efficiency, number of passes, printhead 115 or carriage 110 speed, drop volume, ink density, printhead nozzle resolution, or a combination thereof. The ink efficiency may be defined as the mass of the printing fluid to be set per surface unit, for example, about 10 grams per square meter (g/sqm). The number of passes may be used in, for example, large format printers that comprise a carriage 110 with a plurality of printheads 115 therein, in which different subsets of the printheads from the carriage may print different passes, for example, four or six passes. The carriage speed may be defined as the speed of the scanning printhead 110 from an edge of the width of the substrate to the opposite edge, for example, about 40 inches per second (ips). The drop volume may be defined as the volume of each drop of the printing fluid in a spit, for example, about 12 picolitres (pp. The ink density may be defined as the mass of the printing fluid in a unity of volume, for example, about 1 gram per cubic centimeter (g/cc). The printhead nozzle resolution may be defined as the number of dots of the printing fluid in a unit of surface, for example, about 1200 dots per inch (dpi).

Additionally, or alternatively, the controller 120 may determine the decap parameter based on the length of the print zone, the composition of the printing fluid, and the ambient conditions of the workspace. Additionally, the controller 120 may determine the decap parameter based on the print job itself since the print job may comprise data corresponding to the locations where a given printing fluid is last spat, i.e. nozzles refreshed, and the decap time may be calculated therefrom. Additionally, the controller 120 may determine the decap parameter based on the distance between the service zone 240 and the additional service zone 250 according to the printing apparatus described with reference to FIG. 2B.

The controller 120 may further determine the plurality of spit locations 345A-345F within the service zone 240. The controller 120 may determine the distance between each spit location from the plurality of spit locations 345A-345F to the print zone 230. As mentioned above in the example, the first spitting location 345A is the spitting location which is the closest to the print zone 230 and the sixth spitting location 345 is the spitting location which is the furthest to the print zone 230. It is to be noted that the furthest the spitting location is, the more time and distance the printhead 115 may take to reach the location. In the example, the printhead 115 takes more time to reach the sixth spitting zone 345F than the first spitting zone 345A because of the distance between the spitting zone and the print zone 230.

The controller 120 may further assign a spit location from the plurality of spit locations 345A-345F to each of the plurality of printing fluids based on the detected parameter from the plurality of printing fluids. The parameter may indicate the risk of decap occurrence since it is determined based on the variables that may affect decap.

In an example, the controller 120 may associate a printing fluid from the plurality of printing fluids with the lowest decap time and/or lowest decap distance to the spitting location with the lowest distance to the print zone 230, e.g. first spitting location 345A. Additionally, or alternatively, the controller 120 may associate a printing fluid from the plurality of printing fluids with the highest decap time or highest decap distance to the spitting location with the highest distance to the print zone 230, e.g. sixth spitting location 345F. This may degrade the service zone 240 equally throughout its length with a minimal impact in the decap performance of the plurality of printing fluids.

In another example, the controller 120 may tag the printing fluids with the lowest decap time or the lowest decap distance as comprising a decap risk spitting mode. The controller 120 may also tag the printing fluids with the highest decap time or the highest decap distance as comprising a standard spitting mode. The controller 120 may associate the printing fluids corresponding to the decap risk spitting mode to the spitting location with the lowest distance to the print zone 230, e.g. first spitting location 345A. The controller 120 may associate the printing fluids corresponding to the standard spitting mode to the spitting location with the highest distance to the print zone 230, e.g. sixth spitting location 345F.

The controller 120 may control the printhead 115 to spit an amount of each of the printing fluid from the plurality of printing fluids to the associated spit location of each of the printing fluids.

FIG. 3C is a block diagram illustrating another example of a front view of a service zone 240 with a plurality of spit locations. The service zone 240 comprises a first spitting location 345A. Reference is made to the first spitting location 345A but any other spitting location may be used without departing from the scope of the present disclosure. It was determined by the controller 120 (not shown for simplicity) to associate a printing fluid from the printhead 115 within the carriage 110 to the first spitting location 345A. In service operation, the controller 120 may control the carriage 110 to move the printhead 115 on top of the first spitting location 345A.

The printhead 115 may spit an amount of the printing fluid in the first spitting location 345A in order to refresh the nozzles therein. This amount of printing fluid gets deposited in the first spitting location 345A and accumulates thereon with subsequent servicing operations to refresh the nozzles. The accumulated printing fluid 370 comprises a height (indicated as the reference H in the illustration). If the height H from the accumulated printing fluid 370 reached a printing fluid deposition threshold, it may happen to be close enough to the printhead 115 and cause further issues.

The controller 120 may determine that a spit location from the plurality of spit locations 345A-345F, e.g. first spit location 345A, reached a printing fluid deposition threshold.

In one example the controller 120 may determine that the spit location reached the printing fluid deposition threshold by checking the amount of spits and/or the corresponding amount of printing fluid spit thereon that have occurred in a given spit location 345A-345F. Therefore, if a predetermined amount of spits and/or printing fluid have occurred in the spit location, the controller may determine that the spit location reached the printing fluid deposition threshold.

In another example the printing apparatus may comprise a sensor, e.g. level sensor, to measure if the spit location 345A-345F from the service zone 240 comprises an amount of deposited printing fluid corresponding to the printing fluid deposition threshold. The controller 120 may control the sensor to measure whether the height H of the accumulated printing fluid 370 reaches the height associated with the printing fluid deposition threshold. If the controller 120 determines that the height H of the accumulated printing fluid 370 reaches the height associated with the printing fluid deposition threshold, the controller 120 may determine that the spit location 345A-345F where the measurement have occurred reached the printing fluid deposition threshold.

In the event the controller 120 determined that a spit location 345A-345F reached the printing fluid deposition threshold, the controller 120 may associate the printing fluid associated with the spit location 345A-345F to a different spit location 345A-345F from the service zone 240. In an example, the controller 120 may associate the printing fluid with the closest available spit location 345A-345F from the service zone 240. An available spit location 345A-345F may be understood as a spit location 345A-345F in which the printing fluid deposited thereon has not reached the printing fluid deposition threshold. In an example, if the first spit location 345A associated with a first printing fluid reached the printing fluid deposition threshold, the controller 120 may associate the first printing fluid with the second spit location 345B for further servicing spits of the first printing fluid. In another example, if the sixth spit location 345F associated with a second printing fluid reached the printing fluid deposition threshold, the controller 120 may associate the second printing fluid with the fifth spit location 345D for further servicing spits of the second printing fluid.

FIG. 4 is a flowchart of an example method 400 for determining a spit location. Method 400 may be described below as being executed or performed by a controller, such as the controller 120 of FIG. 1. Method 400 may be implemented in the form of executable instructions stored on a machine-readable storage medium and executed by a single processor or a plurality of processors, and/or in the form of any electronic circuitry, for example digital and/or analog ASIC. In some implementations of the present disclosure, method 400 may include more or less blocks than are shown in FIG. 4. In some implementations, some of the blocks of method 400 may, at certain times, be performed in parallel and/or may repeat.

Method 400 may be performed by a controller from a printing apparatus. At block 420, the controller may determine a spitting mode, e.g. standard spitting mode or decap risk spitting mode, from a set of printing fluids of a printhead, wherein the printhead is in a moveable carriage. At block 440, the controller may determine a spit location within a spittoon, i.e. service zone, to eject an amount of the printing fluid based on the determined spitting mode for each of the printing fluid of the set of printing fluids. At block 460, the controller may control the carriage to move so that the printhead is located over the determined spit location of the spittoon. At block 480, the controller may control the printhead to eject, i.e. spit, the amount of the printing fluid on the determined spit location of the spittoon. The printhead, the carriage, and the controller of method 400 may be the same as or similar to the printhead 115, the carriage 110, and the controller of FIG. 1.

In an example, the controller from method 400 may determine the spitting mode based on at least one of the print mode, the length of the print zone, the speed of the carriage, the composition of the printing fluid, and the ambient conditions.

The method 400 may comprise additional blocks to be performed. In an example, the controller may detect a decap parameter from each printing fluid from the set of printing fluids, and determine the spitting mode, e.g. standard spitting mode or decap risk spitting mode, from each printing fluid from the set of printing fluids based on the corresponding detected decap parameter. Additionally, upon determining that the decap parameter is the decap time, the controller from method 400 may further associate the printing fluid from the set of printing fluids with the lowest decap time to the spit location within the spittoon with the lowest distance to the print zone.

The method 400 may further comprise additional blocks to be performed. For example, the controller may determine that the spit location within the spittoon, i.e. service zone, reached a printing fluid deposition threshold. The controller may also associate the printing fluid associated with the spit location to a different spit location within the spittoon.

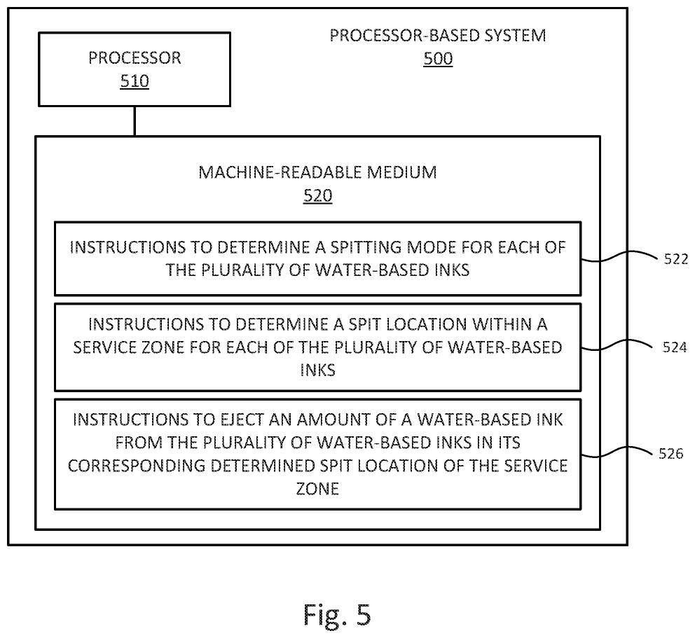

FIG. 5 is a block diagram illustrating a processor-based system 500 that includes a machine-readable medium encoded with example instructions to determine a spit location. In some implementations, the system 500 may be or may form part of a printing device, such as a printer. In some implementations, the system 500 is a processor-based system and may include a processor 510 coupled to a machine-readable medium 520. The processor 510 may include a single-core processor, a multi-core processor, an application-specific integrated circuit (ASIC), a field programmable gate array (FPGA), and/or any other hardware device suitable for retrieval and/or execution of instructions from the machine-readable medium 520 (e.g., instructions 522, 524, and 526) to perform functions related to various examples. Additionally, or alternatively, the processor 510 may include electronic circuitry for performing the functionality described herein, including the functionality of instructions 522, 524, and/or 526. With respect of the executable instructions represented as boxes in FIG. 5, it should be understood that part or all of the executable instructions and/or electronic circuits included within one box may, in alternative implementations, be included in a different box shown in the figures or in a different box not shown.

The machine-readable medium 520 may be any medium suitable for storing executable instructions, such as a random-access memory (RAM), electrically erasable programmable read-only memory (EEPROM), flash memory, hard disk drives, optical disks, and the like. In some example implementations, the machine-readable medium 520 may be a tangible, non-transitory medium, where the term “non-transitory” does not encompass transitory propagating signals. The machine-readable medium 520 may be disposed within the processor-based system 500, as shown in FIG. 5, in which case the executable instructions may be deemed “installed” on the system 500. Alternatively, the machine-readable medium 520 may be a portable (e.g., external) storage medium, for example, that allows system 500 to remotely execute the instructions or download the instructions from the storage medium. In this case, the executable instructions may be part of an “installation package”. As described further herein below, the machine-readable medium may be encoded with a set of executable instructions 522-526.

Instructions 522, when executed by the processor 510, may cause the processor 510 to determine a spitting mode for each of the plurality of water-based inks, i.e. printing fluids. Instructions 524, when executed by the processor 510, may cause the processor 510 to determine a spit location within a service zone for each of the plurality of water-based inks. The instructions 526 to eject an amount of a water-based ink from the plurality of water-based inks in its corresponding determined spit location of the service zone.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

As used herein, the term “about” and “substantially” are used to provide flexibility to a numerical range endpoint by providing that a given value may be, for example, an additional 20% more or an additional 20% less than the endpoints of the range. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

Example implementations can be realized according to the following clauses:

Clause 1: A printing apparatus comprising (i) a carriage comprising a printhead to spit a printing fluid, the carriage to move over a service zone and a print zone; and (ii) a controller to (a) determine a spit location within the service zone associated to the printing fluid; and (b) spit, during a servicing operation, an amount of the printing fluid at the spit location of the service zone associated to the printing fluid.

Clause 2: The printing apparatus of clause 1, wherein the printhead comprises a plurality of printing fluids, the controller further to: (i) obtain a parameter from the plurality of printing fluids; (ii) determine a plurality of spit locations within the service zone, each location at a determined distance from the print zone; and (iii) assign a spit location from the plurality of locations to each of the plurality of printing fluids based on the detected parameter from the plurality of printing fluids.

Clause 3: The printing apparatus of any preceding clause, wherein the parameter is a decap parameter.

Clause 4: The printing apparatus of any preceding clause, wherein the decap parameter is at least one of a decap time or a decap distance, wherein the controller is further to associate a printing fluid from the plurality of printing fluids with the at least one of lowest decap time or lowest decap distance to the spitting location with the lowest distance to the print zone.

Clause 5: The printing apparatus of any preceding clause, wherein the controller further to: (i) determine that a spit location from the plurality of spit locations reached a printing fluid deposition threshold; and (ii) associate the printing fluid associated with the spit location to a different spit location from the service zone.

Clause 6: The printing apparatus of any preceding clause, wherein the controller is further to determine that the spit location reached the printing fluid deposition threshold by checking whether a predetermined amount of spits have occurred in the spit location.

Clause 7: The printing apparatus of any preceding clause, further comprising a sensor to measure if the spit location from the service zone comprises an amount of deposited printing fluid corresponding to the printing fluid deposition threshold.

Clause 8: The printing apparatus of any preceding clause, wherein the controller determines the parameter based on at least one of a print mode, a length of the print zone, a speed of the carriage, the printing fluid, and ambient conditions.

Clause 9: The printing apparatus of any preceding clause, wherein the carriage is further to move over an additional service zone located at a different side of the print zone than the service zone, the controller further to determine the parameter based on a distance between the service zone and the additional service zone.

Clause 10: A method comprising (i) determining a spitting mode from a set of printing fluids of a printhead, wherein the printhead is in a moveable carriage; (ii) determining a spit location within a spittoon to eject an amount of the printing fluid based on the determined spitting mode for each of the printing fluid of the set of printing fluids; (iii) moving the carriage so that the printhead is located over the determined spit location of the spittoon; and (iv) ejecting the amount of the printing fluid on the determined spit location of the spittoon.

Clause 11: The method of clause 10, further comprising: (i) acquiring a decap parameter from each printing fluid from the set of printing fluids; and (ii) determining the spitting mode from each printing fluid from the set of printing fluids based on the corresponding detected decap parameter.

Clause 12: The method of any of the clauses 10 to 11, wherein the decap parameter is a decap time, the method further comprising associating a printing fluid from the set of printing fluids with the lowest decap time to the spit location within the spittoon with the lowest distance to the print zone.

Clause 13: The method of any of the clauses 10 to 12, further comprising determining the spitting mode based on at least one of a print mode, a length of the print zone, a speed of the carriage, the printing fluid, and ambient conditions.

Clause 14: The method of any of the clauses 10 to 13, further comprising (i) determining that the spit location within the spittoon reached a printing fluid deposition threshold; and (ii) associating the printing fluid associated with the spit location to a different spit location within the spittoon.

Clause 15: A non-transitory machine-readable medium storing instructions executable by a processor, the non-transitory machine-readable medium comprising (i) instructions to determine a spitting mode for each of a plurality of water-based inks; (ii) i instructions to determine a spit location within a service zone for each of the plurality of water-based inks; and (iii) instructions to eject an amount of a water-based ink from the plurality of water-based inks in its corresponding determined spit location of the service zone.

What it is claimed is:

1. A printing apparatus comprising:
a carriage comprising a printhead to spit a printing fluid, the carriage to move over a service zone and a print zone; and
a controller to:
determine a spit location within the service zone associated to the printing fluid; and
spit, during a servicing operation, an amount of the printing fluid at the spit location of the service zone associated to the printing fluid.

2. The printing apparatus of claim 1, wherein the printhead comprises a plurality of printing fluids, the controller further to:
obtain a parameter associated to the plurality of printing fluids;
determine a plurality of spit locations within the service zone, each location at a determined distance from the print zone; and
assign a spit location from the plurality of locations to each of the plurality of printing fluids based on the detected parameter from the plurality of printing fluids.

3. The printing apparatus of claim 2, wherein the parameter is a decap parameter.

4. The printing apparatus of claim 3, wherein the decap parameter is at least one of a decap time or a decap distance, wherein the controller is further to associate a printing fluid from the plurality of printing fluids with the at least one of lowest decap time or lowest decap distance to the spitting location with the lowest distance to the print zone.

5. The printing apparatus of claim 2, wherein the controller further to:
determine that a spit location from the plurality of spit locations reached a printing fluid deposition threshold; and
associate the printing fluid associated with the spit location to a different spit location from the service zone.

6. The printing apparatus of claim 5, wherein the controller is further to determine that the spit location reached the printing fluid deposition threshold by checking whether a predetermined amount of spits have occurred in the spit location.

7. The printing apparatus of claim 5, further comprising a sensor to measure if the spit location from the service zone comprises an amount of deposited printing fluid corresponding to the printing fluid deposition threshold.

8. The printing apparatus of claim 2, wherein the controller determines the parameter based on at least one of a print mode, a length of the print zone, a speed of the carriage, the printing fluid, and ambient conditions.

9. The printing apparatus of claim 2, wherein the carriage is further to move over an additional service zone located at a different side of the print zone than the service zone, the controller further to determine the parameter based on a distance between the service zone and the additional service zone.

10. A method comprising:
determining a spitting mode for a set of printing fluids of a printhead, wherein the printhead is in a moveable carriage;
determining a spit location within a spittoon to eject an amount of the printing fluid based on the determined spitting mode for each of the printing fluid of the set of printing fluids;
moving the carriage so that the printhead is located over the determined spit location of the spittoon; and
ejecting the amount of the printing fluid on the determined spit location of the spittoon.

11. The method of claim 10, further comprising:
acquiring a decap parameter from each printing fluid from the set of printing fluids; and
determining the spitting mode for each printing fluid from the set of printing fluids based on the corresponding detected decap parameter.

12. The method of claim 11, wherein the decap parameter is a decap time, the method further comprising associating a printing fluid from the set of printing fluids with the lowest decap time to the spit location within the spittoon with the lowest distance to the print zone.

13. The method of claim 10, further comprising determining the spitting mode based on at least one of a print mode, a length of the print zone, a speed of the carriage, the printing fluid, and ambient conditions.

14. The method of claim 10, further comprising:
determining that the spit location within the spittoon reached a printing fluid deposition threshold; and
associating the printing fluid associated with the spit location to a different spit location within the spittoon.

15. A non-transitory machine readable medium storing instructions executable by a processor, the non-transitory machine-readable medium comprising:
instructions to determine a spitting mode for each of a plurality of water-based inks;
instructions to determine a spit location within a service zone for each of the plurality of water-based inks; and
instructions to eject an amount of a water-based ink from the plurality of water-based inks in its corresponding determined spit location of the service zone.
